(19) United States
(12) Patent Application Publication
(10) Pub. No.: US 2018/0225690 A1
(43) Pub. Date: Aug. 9, 2018

(54) TARGETED DISCOUNTING OF PRODUCTS BASED UPON COST OF OPERATION

(71) Applicant: International Business Machines Corporation, Armonk, NY (US)

(72) Inventors: James E. Carey, Rochester, MN (US); Bryan M. Jones, Rochester, MN (US); Aditi Rajagopal, Rochester, MN (US); Ryan L. Rossiter, Rochester, MN (US)

(21) Appl. No.: 15/425,067

(22) Filed: Feb. 6, 2017

(51) Int. Cl. G06Q 30/02

(52) U.S. Cl. CPC G06Q 30/0207; G06Q 30/0251; G06Q 30/0283

(57) ABSTRACT

Embodiments of the present invention provide a method, system and computer program product for targeted discounting of products based upon cost of operation. In an embodiment of the invention, a method of providing a notification includes predicting i) a first cost of usage for a first product and ii) a second cost of usage for a second product. The method also includes determining a range of discount for the first product based, at least in part, on a comparison of the first usage cost and the second usage cost, and determining a discount for the first product that is included in the range of discount for the first product. Finally, the method includes sending, to a user, a notification that includes the discount for the first product based on a prediction that the discount for the first product is likely to result in the user purchasing the first product.

### BACKGROUND OF THE INVENTION

### Field of the Invention

The present invention relates to targeted advertising and more particularly to targeted discounting of products.

### Description of the Related Art

Targeted marketing is the process of identifying customers and promoting products and services via mediums that are likely to reach those potential customers. In the context of the Internet, targeted marketing delivers targeted messaging to selected consumers at known Internet accessible addresses. The delivery format individual advertisements can range from e-mail messages, to banner advertisements to pop-up notifications and beyond. Targeted advertisements include not only informational content, but in many cases include interactive content and even coupons or discount offers to purchase consumer products online or within the physical infrastructure of a store.

Consumer products when new and unused, typically enjoy a low cost of operation. However, over time, the cost of maintaining a consumer product may increase. In particular, a consumer product reliant on resource utilization such as power, can incur costs over time and as the consumer product loses its out-of-the-box capability to most efficiently utilize resources, the cost of operating the consumer product may increase. As well, a consumer product reliant upon a replaceable component part with a lifespan substantially less than the lifespan of the consumer product logically requires the replacement of the component part on multiple occasion through the course of ownership of the consumer product. Ultimately, the cost of acquiring replacement parts exceeds that of acquiring a new version of the same consumer product.

### BRIEF SUMMARY OF THE INVENTION

Embodiments of the present invention address deficiencies of the art in respect to targeted marketing and provide a novel and non-obvious method, system and computer program product for targeted discounting of products based upon cost of operation. In an embodiment of the invention, a method of providing a notification is provided. The method includes predicting i) a first cost of usage for a first product and ii) a second cost of usage for a second product. The method also includes determining a range of discount for the first product based, at least in part, on a comparison of the first usage cost and the second usage cost, and determining a discount for the first product that is included in the range of discount for the first product. Finally, the method includes sending, to a user, a notification that includes the discount for the first product based on a prediction that the discount for the first product is likely to result in the user purchasing the first product.

In one aspect of the embodiment, the first product is included in the retail stock of a vendor and the second product is currently owned by the user. In another aspect of the embodiment, a cost of usage for a given product is based, at least in part, on at least two of: i) the cost of operation of the given product over time—namely an amount of maintenance that is expected to be required for the given product over a period of time, ii) an amount of resources consumed during a predicted usage of the given product over the period of time, and iii) an initial purchase price for the given product. In yet another aspect of the embodiment, the first cost of usage is greater than the second cost of usage and application of the discount to a purchase of the first product results in a purchase cost that is less than or equal to the second cost of usage. In even yet another aspect of the embodiment, the method further includes determining that the first product was manufactured a threshold period of time after the second product was manufactured. Finally, in even yet a further aspect of the embodiment, the discount for the first product, when applied to an initial sale price of the first product, generates a final sale price for the first product that yields in a threshold profit for a vendor of the first product.

In another embodiment of the invention, an e-commerce marketing data processing system is configured to provide a notification. The system includes a host computing platform of one or more computers, each with memory and at least one processor. The system also includes an e-commerce marketing computer program executing in the memory of the host computing platform and providing in a display of the host computing platform a user interface for specifying a targeted advertisement to one or more target consumers. The system yet further includes a notification module coupled to the e-commerce marketing computer program. The module includes program code that when executes in the host computing platform, performs a method that includes predicting i) a first cost of usage for a first product and ii) a second cost of usage for a second product, determining a range of discount for the first product based, at least in part, on a comparison of the first usage cost and the second usage cost, determining a discount for the first product that is included in the range of discount for the first product, and sending, to a user, a notification that includes the discount for the first product based on a prediction that the discount for the first product is likely to result in the user purchasing the first product.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for targeted discounting of products based upon cost of operation;

FIG. 2 is a schematic illustration of an e-commerce targeted marketing data processing system configured for targeted discounting of products based upon cost of operation; and,

FIG. 3 is a flow chart illustrating a process for targeted discounting of products based upon cost of operation.

### DETAILED DESCRIPTION OF THE INVENTION

Embodiments of the invention provide for targeted discounting of products based upon cost of operation. In accordance with an embodiment of the invention, cost data for the operation of a consumer product is received in memory of an e-commerce marketing data processing system. Utilizing the cost data, the e-commerce marketing data processing system computes an estimated cost of operation of the consumer product for a specified period of time. As well, the specified price of a new version of the consumer product in retail stock of a vendor combined with the future cost of operation of the replacement product is retrieved from a data store along with data indicative of a profit margin for the consumer product. Finally, on condition of the estimated cost of operation exceeding the specified price combined with the future cost of operation of the replacement product less the profit margin but falling below the specified price combined with the future cost of operation of the replacement product, the e-commerce marketing data processing system selects an intermediate price between the specified price combined with the future cost of operation of the replacement product and the specified price combined with the future cost of operation of the replacement product less the profit margin and generates a targeted advertisement with an offer of a discount corresponding to the intermediate price. Finally, the e-commerce marketing data processing system transmits the offer to an end user associated with the consumer product.

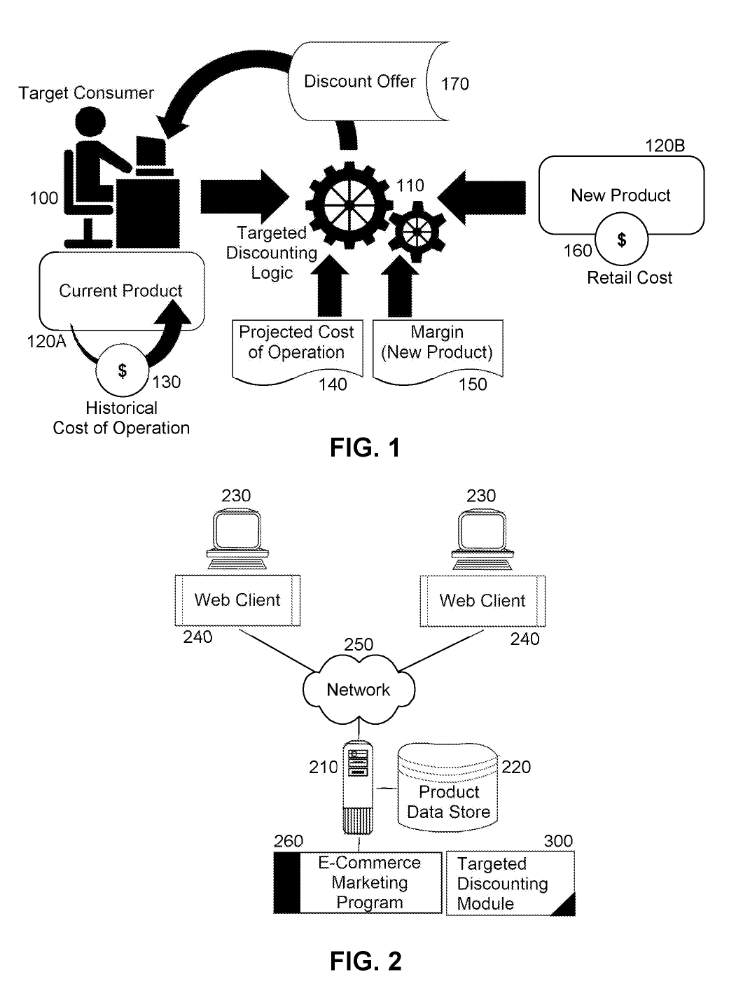

In further illustration, FIG. 1 pictorially shows a process for targeted discounting of products based upon cost of operation. As shown in FIG. 1, targeted discounting logic 110 determines a historical cost of operation 130 of a current product 120A owned by target consumer 100. The determination of the historical cost of operation 130 may include referring to a table of known costs of operation for products like the current product 120A, or the determination of the historical cost of operation 130 may include monitoring cost data for the current product 120A. Thereafter, the targeted discounting logic 110 computes a projected cost of operation 140 over a specified duration of time.

Targeted discounting logic 110 then identifies a new product 120A as a replacement to the current product 120A. As well, the targeted discounting logic 110 identifies both a retail cost 160 of the new product 120B and a sales margin 150 for the new product. The targeted discounting logic 110 then compares the projected cost of operation 140 to the retail cost 160 of the new product 120B. On the condition that the retail cost 160 of the new product 120B exceeds the projected cost of operation 140, but also that the projected cost of operation 140 exceeds the retail cost 160 less the margin 150, the targeted discounting logic 110 computes a discount off the retail cost 160 as a portion of the margin 150 so that a discount offer 170 is generated and transmitted to the target consumer 100 providing the target consumer 100 an opportunity to replace the current product 120A with the new product 120B at a price which falls below the projected cost of operation 140 of the current product 120A.

The process described in connection with FIG. 1 may be implemented in a data processing system. In further illustration, FIG. 2 schematically shows an e-commerce targeted marketing data processing system configured for targeted discounting of products based upon cost of operation. The system includes a host computing platform 210 that includes one or more computers, each with memory and at least one processor. The host computing platform 210 is coupled to different client computers 230 over computer communications network 250. The host computing platform 210 supports the operation of an e-commerce marketing program 260 adapted to transmit advertisements electronically over the computer communications network 250 for display in the client computers 230, for instance in a corresponding Web client 240.

Of note, a targeted discounting module 300 is coupled to the e-commerce marketing program 260. The targeted discounting module 300 includes program code that when executing in the memory of the host computing platform 210 is enabled to select an existing product of a target consumer and determine a cost of operation of the selected existing product based upon data in product data store 220, such as historical cost data and optionally including the original cost of acquisition of the selected existing product. The program code also is enabled to compare the cost of operation of the selected existing product to a cost of operation of a new replacement product for the selected existing product that at least has been manufactured after a threshold period of time from the selected existing product. The program code yet further is enabled, on the condition that the cost of operation of the selected existing product falls below the cost of operation of the new replacement product, but above the cost of operation of the new replacement product less a profit margin of the new replacement product, to compute discount as a portion of the profit margin and direct the e-commerce marketing program 260 to generate and transmit a targeted advertisement to the client computer 230 of the target consumer offering the computed discount on the purchase of the new replacement product.

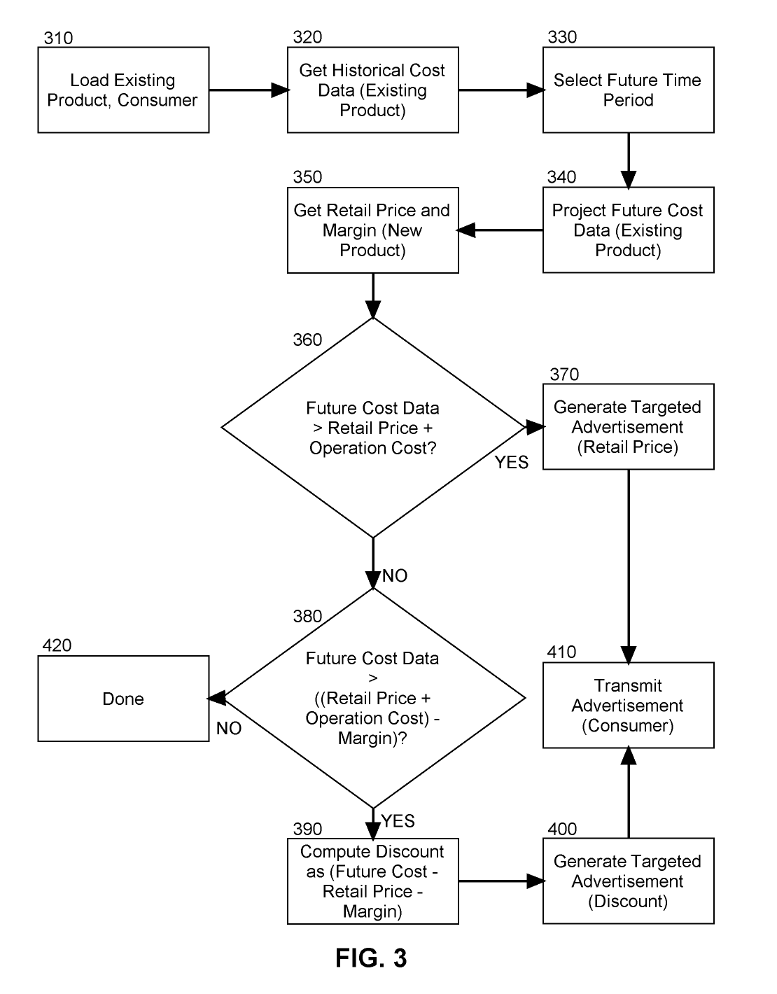

In even yet further illustration of the operation of the targeted discounting module 300, FIG. 3 is a flow chart illustrating a process for targeted discounting of products based upon cost of operation. Beginning in block 310, data for an existing product for an existing customer is loaded into memory of a computer and in block 320, historical cost data for the existing product is retrieved from fixed storage. In block 330, a future time period is specified and in block 340, a future cost of operation of the existing product is computed based upon the future time period and the historical cost data. In block 350, then, a retail price for a new, replacement product is retrieved into memory along with a known profit margin for the replacement product.

In decision block 360, it is determined whether or not the future cost of operation of the existing product exceeds the retail price of the replacement product combined with the future cost of operation of the replacement product. If so, a targeted advertisement pertaining to the replacement product is generated in block 370. Otherwise, in block 380 it is determined whether or not the future cost of the operation of the existing product exceeds the retail price of the replacement product combined with the future cost of operation of the replacement product less the profit margin. If not, the process ends in block 420. But if so, in block 390 a discount is computed as a portion of the profit margin so as to ensure a discounted price that falls below the future cost of operation while ensuring at least a threshold profit margin for the vendor. Thereafter, in block 400 a targeted advertisement pertaining to the replacement product and indicating the computed discount is generated. Finally, in block 410 the generated advertisement is transmitted to the existing customer.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method of providing a notification, the method comprising:
predicting i) a first cost of usage for a first product and ii) a second cost of usage for a second product;
determining a range of discount for the first product based, at least in part, on a comparison of the first usage cost and the second usage cost;
determining a discount for the first product that is included in the range of discount for the first product; and
sending, to a user, a notification that includes the discount for the first product based on a prediction that the discount for the first product is likely to result in the user purchasing the first product.

2. The method of claim 1, wherein the first product is included in the retail stock of a vendor and the second product is currently owned by the user.

3. The method of claim 1, wherein a cost of usage for a given product is based, at least in part, on at least two of:
i) an amount of maintenance that is expected to be required for the given product over a period of time,
ii) an amount of resources consumed during a predicted usage of the given product over the period of time, and
iii) an initial purchase price for the given product.

4. The method of claim 1, wherein i) the first cost of usage is greater than the second cost of usage and ii) application of the discount to a purchase of the first product results in a purchase cost that is less than or equal to the second cost of usage.

5. The method of claim 1, further comprising:
determining that the first product was manufactured a threshold period of time after the second product was manufactured.

6. The method of claim 1, wherein the discount for the first product, when applied to an initial sale price of the first product, generates a final sale price for the first product that yields in a threshold profit for a vendor of the first product.

7. An e-commerce marketing data processing system configured to provide a notification, the system comprising:
a host computing platform comprising one or more computers, each with memory and at least one processor;
an e-commerce marketing computer program executing in the memory of the host computing platform, the e-commerce marketing computer program providing in a display of the host computing platform a user interface for specifying a targeted advertisement to one or more target consumers; and,
a notification module coupled to the e-commerce marketing computer program, the module comprising program code that when executes in the host computing platform, performs a method comprising:
predicting i) a first cost of usage for a first product and ii) a second cost of usage for a second product;
determining a range of discount for the first product based, at least in part, on a comparison of the first usage cost and the second usage cost;
determining a discount for the first product that is included in the range of discount for the first product; and
sending, to a user, a notification that includes the discount for the first product based on a prediction that the discount for the first product is likely to result in the user purchasing the first product.

8. The system of claim 7, wherein the first product is included in the retail stock of a vendor and the second product is currently owned by the user.

9. The system of claim 7, wherein a cost of usage for a given product is based, at least in part, on at least two of:
i) an amount of maintenance that is expected to be required for the given product over a period of time,
ii) an amount of resources consumed during a predicted usage of the given product over the period of time, and
iii) an initial purchase price for the given product.

10. The system of claim 7, wherein i) the first cost of usage is greater than the second cost of usage and ii) application of the discount to a purchase of the first product results in a purchase cost that is less than or equal to the second cost of usage.

11. The system of claim 7, wherein the method further comprises:
determining that the first product was manufactured a threshold period of time after the second product was manufactured.

12. The system of claim 7, wherein the discount for the first product, when applied to an initial sale price of the first product, generates a final sale price for the first product that yields in a threshold profit for a vendor of the first product.

13. A computer program product for providing a notification, the computer program product comprising a computer readable storage medium having program instructions embodied therewith, the program instructions executable by a device to cause the device to perform a method comprising:
predicting i) a first cost of usage for a first product and ii) a second cost of usage for a second product;
determining a range of discount for the first product based, at least in part, on a comparison of the first usage cost and the second usage cost;
determining a discount for the first product that is included in the range of discount for the first product; and
sending, to a user, a notification that includes the discount for the first product based on a prediction that the discount for the first product is likely to result in the user purchasing the first product.

14. The computer program product of claim 13, wherein the first product is included in the retail stock of a vendor and the second product is currently owned by the user.

15. The computer program product of claim 13, wherein a cost of usage for a given product is based, at least in part, on at least two of:
i) an amount of maintenance that is expected to be required for the given product over a period of time,
ii) an amount of resources consumed during a predicted usage of the given product over the period of time, and
iii) an initial purchase price for the given product.

16. The computer program product of claim 13, wherein i) the first cost of usage is greater than the second cost of usage and ii) application of the discount to a purchase of the first product results in a purchase cost that is less than or equal to the second cost of usage.

17. The computer program product of claim 13, wherein the method further comprises:
determining that the first product was manufactured a threshold period of time after the second product was manufactured.

18. The computer program product of claim 13, wherein the discount for the first product, when applied to an initial sale price of the first product, generates a final sale price for the first product that yields in a threshold profit for a vendor of the first product.
